(19) United States
(12) Patent Application Publication
(10) Pub. No.: US 2015/0120627 A1
(43) Pub. Date: Apr. 30, 2015

(54) CAUSAL SALIENCY TIME INFERENCE

(71) Applicant: QUALCOMM Incorporated, San Diego, CA (US)

(72) Inventors: Jason Frank HUNZINGER, Escondido, CA (US); Thomas Jiaqian ZHENG, San Diego, CA (US)

(73) Assignee: QUALCOMM INCORPORATED, San Diego, CA (US)

(21) Appl. No.: 14/160,128

(22) Filed: Jan. 21, 2014

Related U.S. Application Data
(60) Provisional application No. 61/897,024, filed on Oct. 29, 2013.

(51) Int. Cl. G06N 3/08

(52) U.S. Cl. CPC G06N 3/08
USPC 706/20

(57) ABSTRACT

Methods and apparatus are provided for causal learning in which logical causes of events are determined based, at least in part, on causal saliency. One example method for causal learning generally includes observing one or more events with an apparatus, wherein the events are defined as occurrences at particular relative times; selecting a subset of the events based on one or more criteria; and determining a logical cause of at least one of the events based on the selected subset.

### CLAIM OF PRIORITY UNDER 35 U.S.C. §119

This application claims benefit of U.S. Provisional Patent Application Ser. No. 61/897,024, filed Oct. 29, 2013 and entitled “Causal Saliency Time Inference,” which is herein incorporated by reference in its entirety.

### BACKGROUND

1. Field

Certain aspects of the present disclosure generally relate to learning systems (e.g., artificial nervous systems) and, more particularly, to determining logical causes of events using causal saliency.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

One type of artificial neural network is the spiking neural network, which incorporates the concept of time into its operating model, as well as neuronal and synaptic state, thereby providing a rich set of behaviors from which computational function can emerge in the neural network. Spiking neural networks are based on the concept that neurons fire or “spike” at a particular time or times based on the state of the neuron, and that the time is important to neuron function. When a neuron fires, it generates a spike that travels to other neurons, which, in turn, may adjust their states based on the time this spike is received. In other words, information may be encoded in the relative or absolute timing of spikes in the neural network.

### SUMMARY

Certain aspects of the present disclosure generally relate to inference learning through determining logical causes of events using causal saliency.

Certain aspects of the present disclosure provide a method for causal learning. The method generally includes observing one or more events with an apparatus, wherein the events are defined as occurrences at particular relative times; selecting a subset of the events based on one or more criteria; and determining a logical cause of at least one of the events based on the selected subset.

Certain aspects of the present disclosure provide an apparatus for causal learning. The apparatus generally includes a processing system and a memory coupled to the processing system. The processing system is typically configured to observe one or more events, defined as occurrences at particular relative times; to select a subset of the events based on one or more criteria; and to determine a logical cause of at least one of the events based on the selected subset.

Certain aspects of the present disclosure provide an apparatus for causal learning. The apparatus generally includes means for observing one or more events, defined as occurrences at particular relative times; means for selecting a subset of the events based on one or more criteria; and means for determining a logical cause of at least one of the events based on the selected subset.

Certain aspects of the present disclosure provide a computer program product for causal learning. The computer program product generally includes a non-transitory computer-readable medium (e.g., a storage device) having code for observing one or more events, defined as occurrences at particular relative times; for selecting a subset of the events based on one or more criteria; and for determining a logical cause of at least one of the events based on the selected subset.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 illustrates an example processing unit (neuron) of a computational network (neural system or neural network), in accordance with certain aspects of the present disclosure.

FIG. 3 illustrates an example spike-timing dependent plasticity (STDP) curve in accordance with certain aspects of the present disclosure.

FIG. 4 is an example graph of state for an artificial neuron, illustrating a positive regime and a negative regime for defining behavior of the neuron, in accordance with certain aspects of the present disclosure.

FIG. 5 illustrates two different perspectives on predictive relationship inference, in accordance with certain aspects of the present disclosure.

FIG. 6 illustrates events being relevant on a relative time scale compared to other retained events, in accordance with certain aspects of the present disclosure.

FIG. 7 illustrates an example learning method using causal saliency, in accordance with certain aspects of the present disclosure.

FIG. 8 illustrates correlative and logical causality forms, in accordance with certain aspects of the present disclosure.

FIG. 9 illustrates determining a logical expression by bootstrapping the correlative temporal relationships, in accordance with certain aspects of the present disclosure.

FIG. 10 is a block diagram of an example causal-saliency causal-inference learning model, in accordance with certain aspects of the present disclosure.

FIG. 11 is a flow diagram of example operations for causal learning, in accordance with certain aspects of the present disclosure.

FIG. 11A illustrates example means capable of performing the operations shown in FIG. 11.

FIG. 12 illustrates an example implementation for causal learning using a general-purpose processor, in accordance with certain aspects of the present disclosure.

FIG. 13 illustrates an example implementation for causal learning where a memory may be interfaced with individual distributed processing units, in accordance with certain aspects of the present disclosure.

FIG. 14 illustrates an example implementation for causal learning based on distributed memories and distributed processing units, in accordance with certain aspects of the present disclosure.

FIG. 15 illustrates an example implementation of a neural network in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

### An Example Neural System

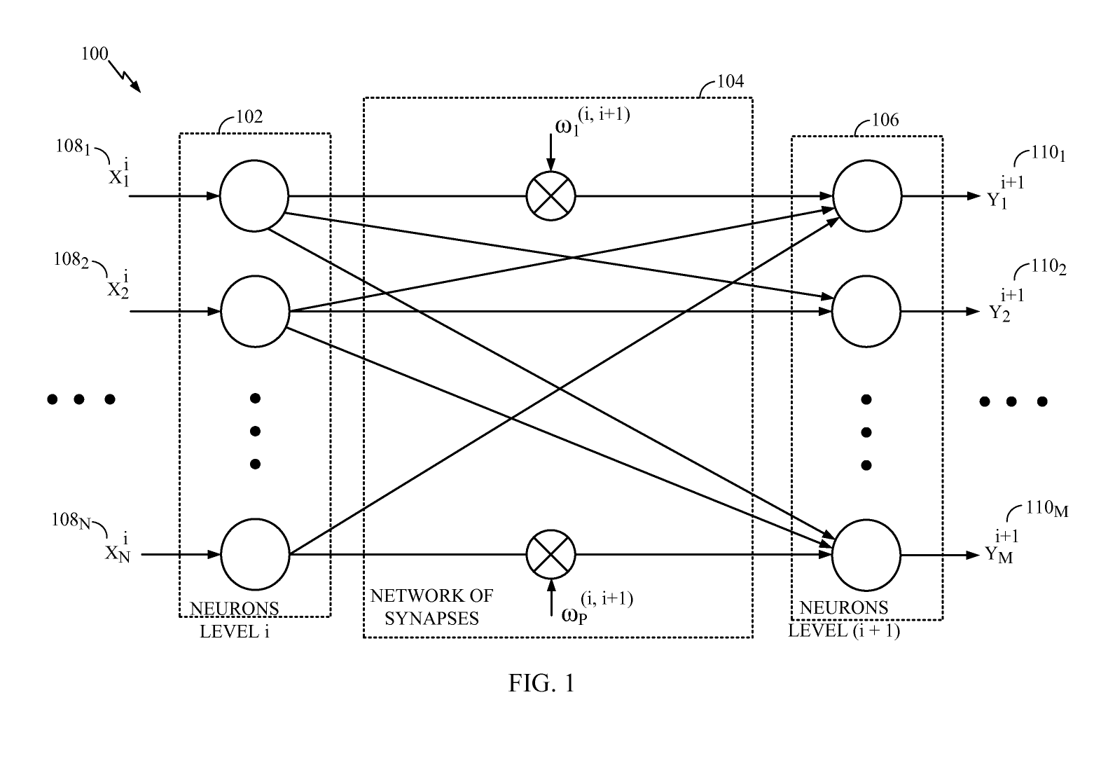

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104 (i.e., feed-forward connections). For simplicity, only two levels of neurons are illustrated in FIG. 1, although fewer or more levels of neurons may exist in a typical neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by a plurality of neurons of a previous level (not shown in FIG. 1). The signal 108 may represent an input (e.g., an input current) to the level 102 neuron. Such inputs may be accumulated on the neuron membrane to charge a membrane potential. When the membrane potential reaches its threshold value, the neuron may fire and generate an output spike to be transferred to the next level of neurons (e.g., the level 106). Such behavior can be emulated or simulated in hardware and/or software, including analog and digital implementations.

In biological neurons, the output spike generated when a neuron fires is referred to as an action potential. This electrical signal is a relatively rapid, transient, all-or nothing nerve impulse, having an amplitude of roughly 100 mV and a duration of about 1 ms. In a particular aspect of a neural system having a series of connected neurons (e.g., the transfer of spikes from one level of neurons to another in FIG. 1), every action potential has basically the same amplitude and duration, and thus, the information in the signal is represented only by the frequency and number of spikes (or the time of spikes), not by the amplitude. The information carried by an action potential is determined by the spike, the neuron that spiked, and the time of the spike relative to one or more other spikes.

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104). For certain aspects, these signals may be scaled according to adjustable synaptic weights w₁^{(i,i+1)}, . . . , w_{P}^{(i,i+1)} (where P is a total number of synaptic connections between the neurons of levels 102 and 106). For other aspects, the synapses 104 may not apply any synaptic weights. Further, the (scaled) signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

Biological synapses may be classified as either electrical or chemical. While electrical synapses are used primarily to send excitatory signals, chemical synapses can mediate either excitatory or inhibitory (hyperpolarizing) actions in postsynaptic neurons and can also serve to amplify neuronal signals. Excitatory signals typically depolarize the membrane potential (i.e., increase the membrane potential with respect to the resting potential). If enough excitatory signals are received within a certain period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching threshold. In addition to counteracting synaptic excitation, synaptic inhibition can exert powerful control over spontaneously active neurons. A spontaneously active neuron refers to a neuron that spikes without further input, for example, due to its dynamics or feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and the like. Each neuron (or neuron model) in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, wherein synaptic weight changes may relate to changes of the memristor resistance. With nanometer feature-sized memristors, the area of neuron circuit and synapses may be substantially reduced, which may make implementation of a very large-scale neural system hardware implementation practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, wherein a particular functionality may be based on synaptic weights stored in a memory card currently attached to the neural processor.

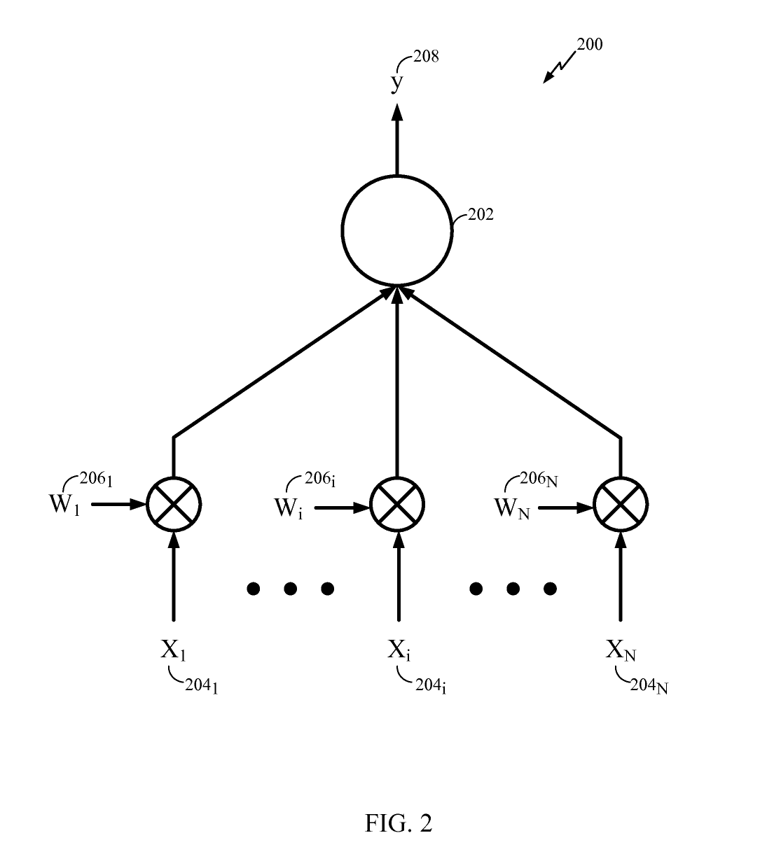

FIG. 2 illustrates an example 200 of a processing unit (e.g., an artificial neuron 202) of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (x₁-x_{N}), which may be signals external to the neural system, or signals generated by other neurons of the same neural system, or both. The input signal may be a current or a voltage, real-valued or complex-valued. The input signal may comprise a numerical value with a fixed-point or a floating-point representation. These input signals may be delivered to the neuron 202 through synaptic connections that scale the signals according to adjustable synaptic weights 2061-206N (w₁-w_{N}), where N may be a total number of input connections of the neuron 202.

The neuron 202 may combine the scaled input signals and use the combined scaled inputs to generate an output signal 208 (i.e., a signal y). The output signal 208 may be a current, or a voltage, real-valued or complex-valued. The output signal may comprise a numerical value with a fixed-point or a floating-point representation. The output signal 208 may be then transferred as an input signal to other neurons of the same neural system, or as an input signal to the same neuron 202, or as an output of the neural system.

The processing unit (neuron 202) may be emulated by an electrical circuit, and its input and output connections may be emulated by wires with synaptic circuits. The processing unit, its input and output connections may also be emulated by a software code. The processing unit may also be emulated by an electric circuit, whereas its input and output connections may be emulated by a software code. In an aspect, the processing unit in the computational network may comprise an analog electrical circuit. In another aspect, the processing unit may comprise a digital electrical circuit. In yet another aspect, the processing unit may comprise a mixed-signal electrical circuit with both analog and digital components. The computational network may comprise processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Some examples of the learning rule are the spike-timing-dependent plasticity (STDP) learning rule, the Hebb rule, the Oja rule, the Bienenstock-Copper-Munro (BCM) rule, etc. Very often, the weights may settle to one of two values (i.e., a bimodal distribution of weights). This effect can be utilized to reduce the number of bits per synaptic weight, increase the speed of reading and writing from/to a memory storing the synaptic weights, and to reduce power consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate in together or separately, in sequence or in parallel. Different types of synapses may have different lookup tables or formulas and parameters for each of the different plasticity types that apply. Thus, the methods would access the relevant tables for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synaptic delay may change only when a weight change occurs or if weights reach zero, but not if the weights are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as to computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity, and homeostatic plasticity.

STDP is a learning process that adjusts the strength of synaptic connections between neurons, such as those in the brain. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. In contrast, long-term depression (LTD) may occur if an input spike tends, on average, to occur immediately after an output spike. Then, that particular input is made somewhat weaker, hence the name “spike-timing-dependent plasticity.” Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to zero or near zero.

Since a neuron generally produces an output spike when many of its inputs occur within a brief period (i.e., being sufficiently cumulative to cause the output), the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t=tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , t > 0 \\ {a}_{-} {e}^{t / {k}_{-}} , t < 0\end{matrix} , \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

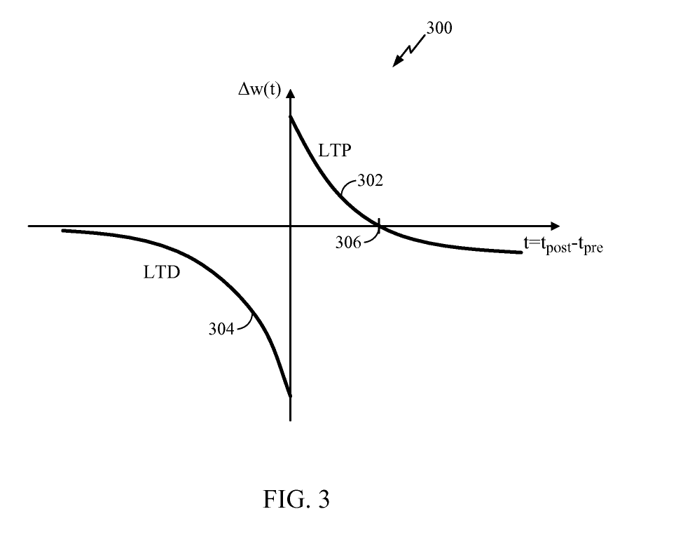

FIG. 3 illustrates an example graph 300 of a synaptic weight change as a function of relative timing of pre-synaptic and post-synaptic spikes in accordance with STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset may be applied to the LTP (causal) portion 302 of the STDP graph. A point of cross-over 306 of the x-axis (y=0) may be configured to coincide with the maximum time lag for considering correlation for causal inputs from layer i−1 (presynaptic layer). In the case of a frame-based input (i.e., an input is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics,

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in biologically-consistent linear fashion. The time constant in the supra-threshold regime, positive by convention, reflects anti-leaky channel dynamics generally driving a cell to spike while incurring latency in spike-generation.

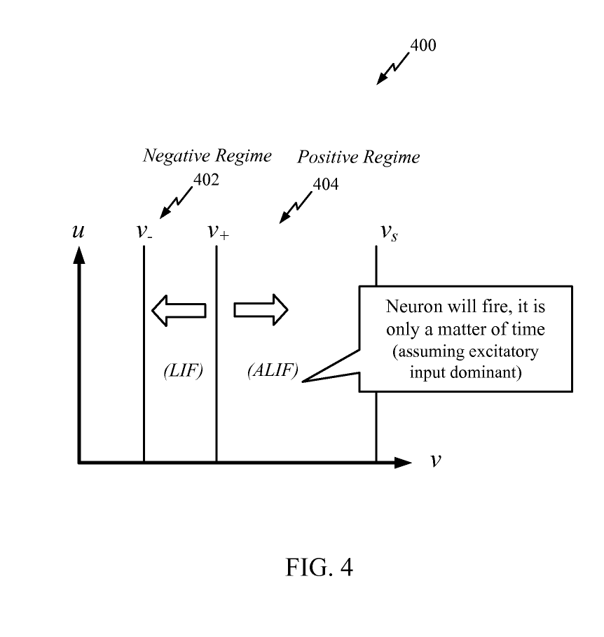

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are

q_{ρ}=−τ_{ρ}βu−v_{τ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τₚ time-constant parameters control not only the exponential decays, but also the null-cline slopes in each regime separately.

The model is defined to spike when the voltage v reaches a value vₛ. Subsequently, the state is typically reset at a reset event (which technically may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time required to reach a particular state. The close form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ, then the closed-form solution for the amount of time, or relative delay, until a spike occurs as measured from the time that the voltage is at a given state v is

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily require iterative methods or Numerical methods. An event-based implementation is also possible at a limited time resolution in a step-based simulator by only updating the model if an event occurs at or between steps or by “step-event” update.

### Neural Coding

A useful neural network model, such as one composed of the artificial neurons 102, 106 of FIG. 1, may encode information via any of various suitable neural coding schemes, such as coincidence coding, temporal coding or rate coding. In coincidence coding, information is encoded in the coincidence (or temporal proximity) of action potentials (spiking activity) of a neuron population. In temporal coding, a neuron encodes information through the precise timing of action potentials (i.e., spikes) whether in absolute time or relative time. Information may thus be encoded in the relative timing of spikes among a population of neurons. In contrast, rate coding involves coding the neural information in the firing rate or population firing rate.

If a neuron model can perform temporal coding, then it can also perform rate coding (since rate is just a function of timing or inter-spike intervals). To provide for temporal coding, a good neuron model should have two elements: (1) arrival time of inputs affects output time; and (2) coincidence detection can have a narrow time window. Connection delays provide one means to expand coincidence detection to temporal pattern decoding because by appropriately delaying elements of a temporal pattern, the elements may be brought into timing coincidence.

### Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

### Inputs

An input to a neuron model may include Dirac delta functions, such as inputs as currents, or conductance-based inputs. In the latter case, the contribution to a neuron state may be continuous or state-dependent.

### Example Causal-Saliency Causal-Inference Learning

Typical approaches to systems for learning causal inference have one or more of the following limitations. First, relations are limited in form to pair-wise metrics of causality from event A to event B (e.g., a plant may be more likely to grow if it has sunlight). The metrics are therefore limited and typically statistical, even though there may be little or no randomness. Second, relations are arbitrarily limited in time, such as by temporal traces, which typically assume causality has a limited temporal range and that events are more causally related merely due to temporal proximity. Even in cases where the assumption might hold, the time span is a system parameter, not learned. Third, combinations of relations have limited scalability, partly as a result of the above issues. As the number of events increases and the time range increases, the number of combinations of events becomes intractable.

Certain aspects of the present disclosure overcome all of the above by a combination of distinguishing the time of events, inferring the earliest cause, and determining logical causes (rather than only pair-wise causes) while providing a scalable framework that is capable of using limited working memory by employing a concept of causal saliency. Certain aspects of the present disclosure may apply to learning in artificial nervous systems. However, aspects of the present disclosure are valid for any suitable learning system.

Graphical methods of causal inference typically involve a graph of nodes representing conceptual events. Each node (vertex) is connected to every other node by a directional edge. If there are N possible events (represented by N nodes), there are 2N² directed edges. Each edge has an associated causal metric (e.g., a Granger causality measure) reflecting the degree to which the source node (cause) is considered to be causally related to the destination node. Methods of causal inference (a type of inductive reasoning) are typically used to learn the causal metric. However, the metric depends on the temporal relation between events and, typically, the causal relation between events is considered only for a predetermined time (e.g., based on some time trace or efficacy decay). Otherwise the number of combinations of event pairs becomes intractable. But this limits the meaningfulness of the causal metric.

Typically, the significance of an event in the past is determined by a value decaying with a particular predetermined time constant. As a result the causality metric confuses (i.e., makes indistinguishable) causality with proximity in time. Now, one could certainly add edges for different time spans, but only an infinite number may account for all time differences. If the concept of decaying relevance is retained, one might consider a finite number of time spans, each with different time constants, which would still blur the distinction between causality and time proximity, only by different amounts and at the cost of 2N² more edges for each time span.

Moreover, typical metrics of causality, such as Granger causality, are statistical measures. Basically, one event is considered to Granger-cause a future event if it provides statistically significant information about the future event's occurrence. In general, however, there are multiple causes of future effects (e.g., a plant grows if it has sunlight and water, but no pests). Each factor contributes statistically, ignoring all the others, but those statistics do not account for basic deterministic logical inferences that humans make easily any day. In fact, there may be no randomness in the observations at all. With only one edge in a given direction between two nodes, it is not possible to capture general logical relationships. Now, one could certainly add edges for all combinations of logical relations. Each logical relation may depend on up to N nodes, and there are on the order of 2^{N} possible logical combinations of those sources (sunlight and water, sunlight but no water, . . . ) to consider with 2 possible results each. This would indicate on the order of N²2^{N+1} “edges” in the graph (no longer edges because they have multiple source nodes).

In summary, the problems with the prior methods are multi-fold: lack of scalability, lack of ability to distinguish causality from temporal proximity, and lack of ability to make deterministic or logical inferences as opposed to pair-wise statistical inferences. Accordingly, what is needed is an improved method for artificial inference learning.

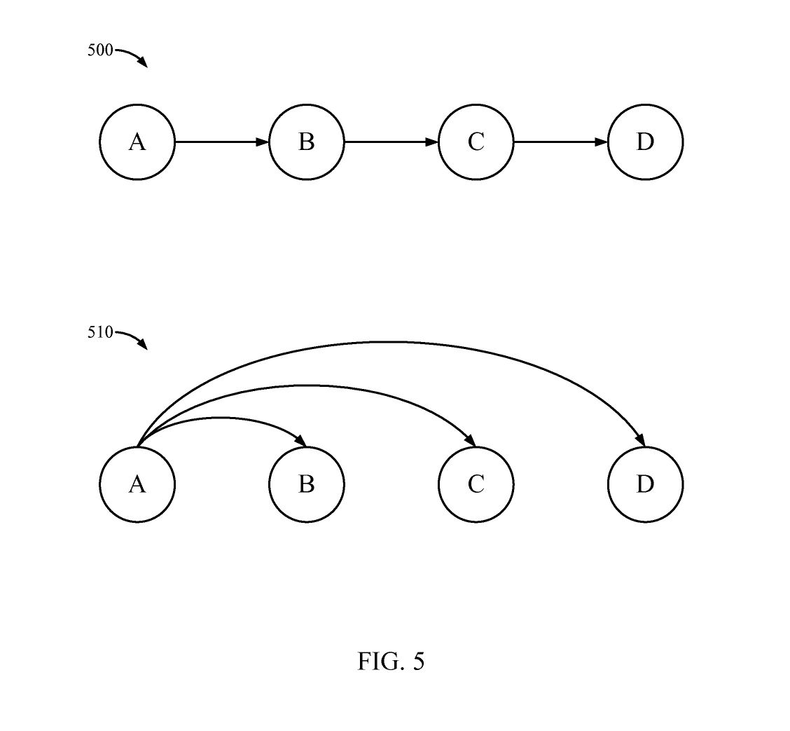

Certain aspects of the present disclosure overcome the aforementioned problems by taking a radically different approach to the task of causal inference. First, certain aspects of the present disclosure consider only a relatively small subset of events for possible logical causal inference. An important element of certain aspects is the method of selecting which events to consider. Moreover, certain aspects of the present disclosure consider the earliest event providing statistically significant information about another event as the most important (i.e., valuable). The difference can be explained with an example of four events observed repeatedly in the following order: A, B, C, D. Two perspectives on predictive relationship inference are shown in FIG. 5. The upper diagram 500 depicts the classical view of each event “causing” the next. However, an alternative viewpoint considered in certain aspects of the present disclosure is depicted in the bottom diagram 510: the first event is the most valuable because it can predict all of the subsequent events. Absent additional information and having limited working memory, one may thus be motivated to hold in memory the most valuable events. The viewpoint considered in certain aspects of the present disclosure provides this information.

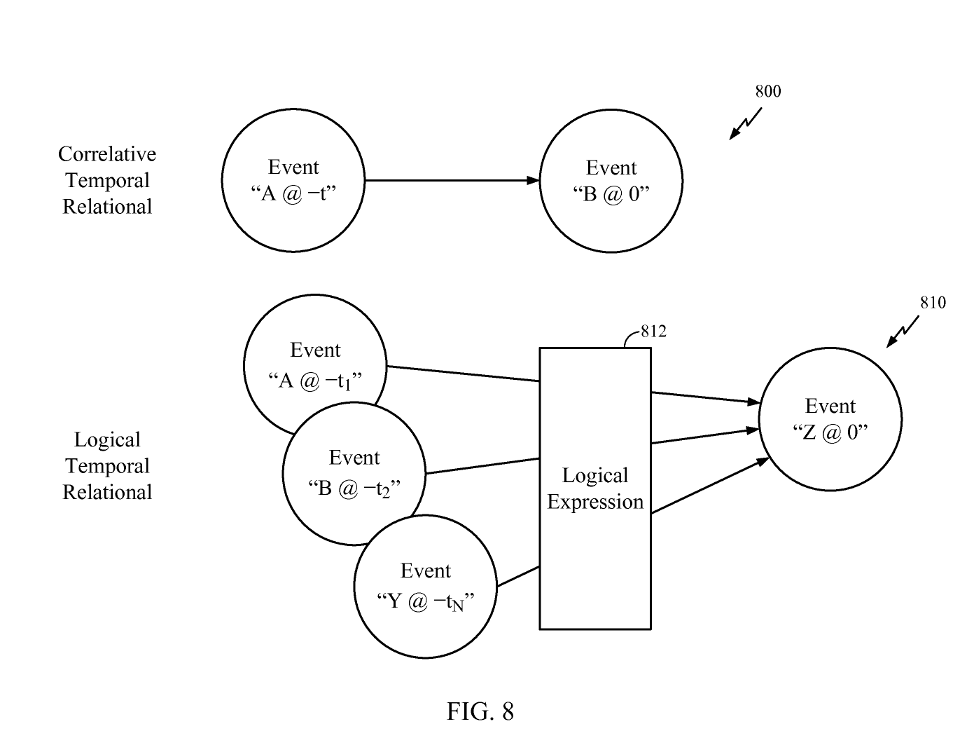

Second, certain aspects of the present disclosure consider an individual event as comprising both the event (i.e., an occurrence) in its conventional conceptual sense, as well as the temporal framework of the event. In other words, events are to be defined not only by what happened, but by when, relatively speaking, the event occurred. Consequently, events at different times are different events. Thus, without loss of generality, a causal relation may be learned as event “A at time −t” causes event “B at time 0,” as illustrated in the correlative temporal relational diagram 800 of FIG. 8. Learning of a correlative temporal pair-wise map of the form Event A at −t→Event B may be performed using unlimited working memory and incorporating relative time in this correlation learning. Moreover, such time t may be represented logarithmically. The larger this time t is, the less precision that may be desired.

The action alone of watering a plant is not an event in this sense. If a plant was watered three days ago, that is an event because there is now a temporal framework associated with the event. Now, the plant might have been watered every day, each being a separate event. The solution to this scalability issue is provided by certain aspects of the present disclosure: selecting which subset of events to consider. Those events are relevant on the relative time scale compared to other retained events.

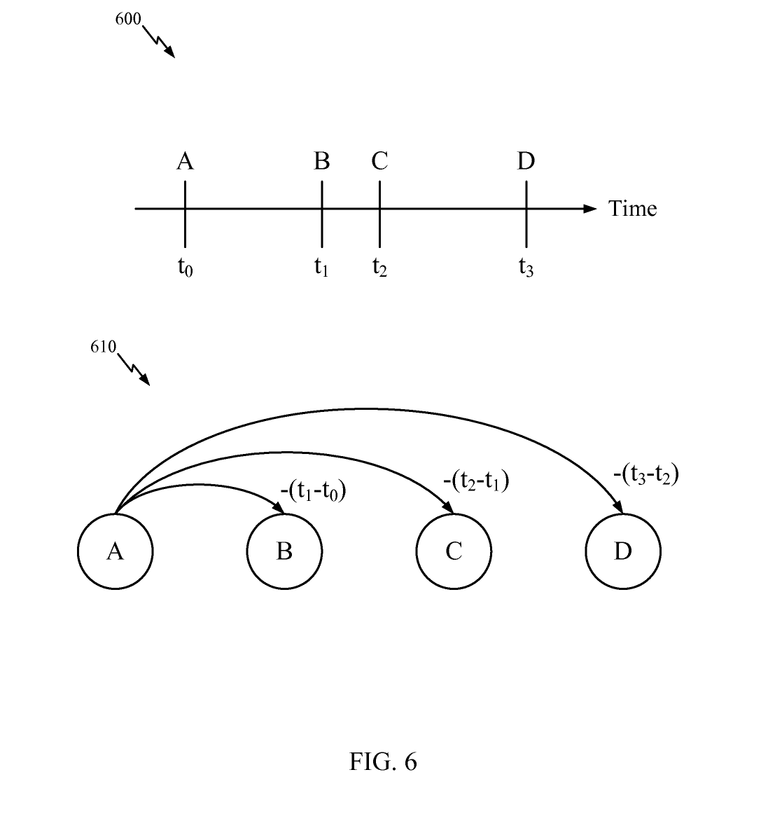

For example, consider the four events A, B, C, and D occurring as shown in FIG. 6 at the times indicated in the plot 600. FIG. 6 also depicts the temporal relationship considered between the first event A and the other events in the diagram 610: the predictive statistical information about event B is given by event A at a relative time t₁−t₀ in the past (considering the time of event B as 0, or “now,” means the relevant event A was at −(t₁−₀)). The diagram 610 also shows that the relevant event A for the other events (C, D) is different because event A occurred at a different relative time in the past.

According to certain aspects, a subset of events are selected for consideration based on any of various suitable criteria (or a combination thereof), such as causal saliency, recurrence, distinctiveness or rarity, and/or temporal proximity. As used herein, “causal saliency” generally refers to the degree to which an event stands out from other events from the perspective of causal inference. For example, if an unpredictable event occurs, it may be considered more causally salient than an event that occurs predictably. The more often an unpredictable event occurs, the more causally salient it may be. Moreover, the more recently an event occurred, the more salient the event is considered, but recentness does not necessarily trump other causal saliency factors. The failure of a predicted event to occur is also a potentially causally salient event: the absence of occurrence at a particular time or during a certain period. The same factors may apply to the failure of a predicted event.

Relationships may most likely be considered among causally salient events, not all events, and independently of the time between their occurrences. The causal salience of an event may most likely be determined (e.g., inferred) by the current state of learned causal relations. A limited number of the most causally salient events may most likley be retained in working memory to be considered for relationships with yet-to-occur events. By limiting working memory, scalability can be achieved while considering causal relationships between the most causally salient events.

Presented with a repeating event sequence A, B, C, a typical approach might be to learn the relationships A→B and B→C. In contrast with this, certain aspects of the present disclosure consider the relationships A→B and A→C. In effect, if given limited working memory, the system may most likely discard (e.g., forget) event B before event A for a couple reasons. First, event B has less predictive value for event C (i.e., event A can predict event C earlier than event B can). Second, event A is unpredictable and thus more salient than event B, which is predictable.

When learning begins, few or no events may be predictable, and—given a constraint on the subset of events that may be considered at a time—the subset may be determined more by temporal proximity, recurrence rate, or randomly. As causal learning proceeds, more events become predictable, and events with less proximal temporal relation and less frequent occurrence may be considered as well as or more than before. Note also that the subset of events under consideration at any given time may be of particular relevance for the next level of learning.

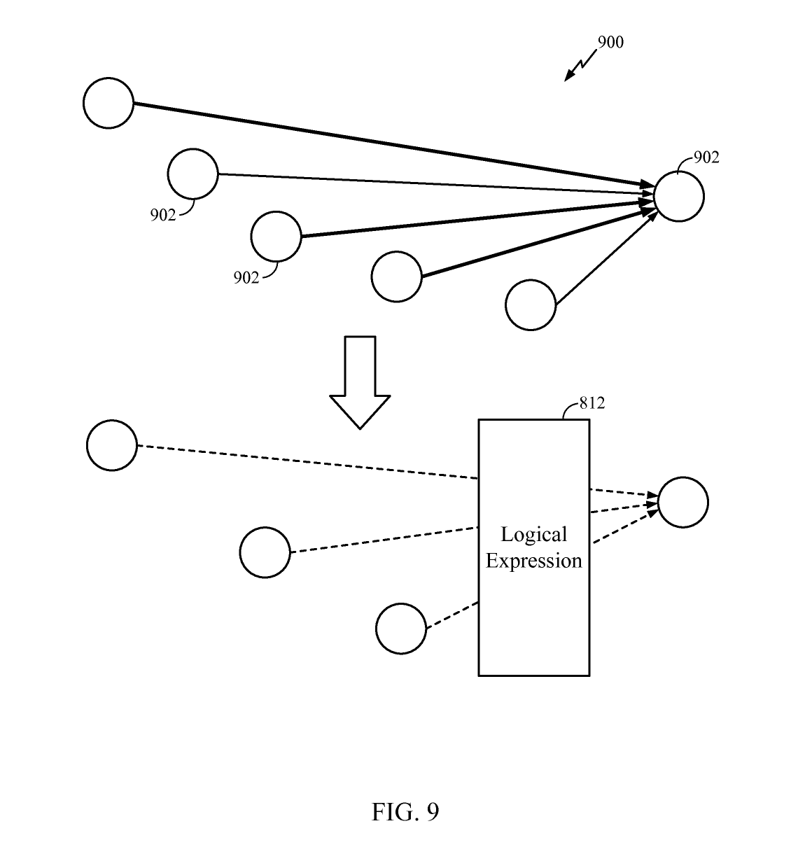

Relationships should have a logical structure—as illustrated by the logical temporal relation diagram 810 in FIG. 8—so that deterministic logical relations (e.g., logical expression 812) can be learned (e.g., a plant grows if it has sunlight and water, but no pests). According to certain aspects, a structured causality map may be bootstrapped using a pair-wise correlative map 900 of events 902, as illustrated in FIG. 9. This bootstrapping may create candidate logical structures for learning on subsequent observations. Logical relations may be learned using a linear system utilizing the general temporal computational principles.

Real world observations are often represented in science by continuous time series (or periodically sampled time series). However, people think of things in terms of events (e.g., a stock goes up on Monday or a tree falls in the night). In this sense, one may think of discrete events rather than continuous variables, and one may think of these events in a variable framework of time. The resolution of that framework of time might expand logarithmically into the past (e.g., seeds were planted 1 year ago or 1 day ago).

Fundamentally, according to certain aspects of the present disclosure, any continuous time series can be converted into one or more events, each with associated temporal frameworks. This may be accomplished by feature learning, such as temporal spike timing learning or machine learning methods. What is important is the sparsification of continuous inputs into discrete events.

According to certain aspects, generalizations of causal relations can be found by examining the causal inferences made. If two events have the same or substantially similar causal logical relation to a third event, the system may generalize the two events as belonging to a class. As a result, or to test this hypothesis, a class event can be added. Whenever an event belonging to the class occurs, the class event is considered as with specific events in terms of the learning mechanisms.

This aspect of generalization also relates to interactive learning, including asking questions and active intervention. Questions can be generated by examining learned relations (whether between specific events or class events). Effectively, this amounts to requesting input that conforms to a particular pattern, such as X and Y cause Z, where X and Z are specified by Y is unknown/free. Alternatively, this may amount to asking if there are any examples of input conforming to a particular pattern or instance, such as whether there exists any evidence of X and Y causing Z or whether X and Y are ever observed in the same time frame. Recall that events, in the context of certain aspects of the present disclosure, have an associated relative time frame which makes formulating this type of query possible. Some events may also be the internal or external action generated by the (artificial nervous) system, artificial neuron, or other apparatus itself. In this case, these events may be changed. The apparatus can intervene in a future sequence to test a hypothesis or effectively ask what would happen if a particular event did or did not occur. According to certain aspects, such hypotheses can be developed based on potential or determined generalizations. A similar causation relation or substitution suggests a possible class, a class for one relation suggests a member event would also fit another causal relation in common with a class member, and so on, are candidates for interactive learning. Thus, generalization provides a basis for interaction or intervention, and ensuing input provides a basis for further generalization.

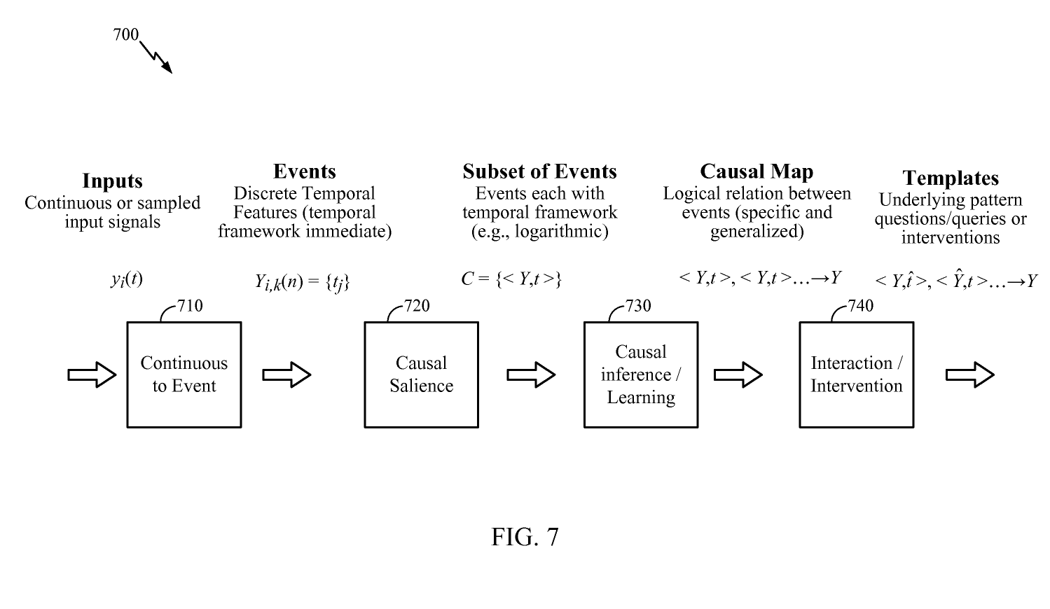

FIG. 7 illustrates an example learning process 700 using causal saliency, in accordance with certain aspects of the present disclosure. Continuous or sampled input signals may be converted to events, as defined herein, at 710. A subset of the events may be selected based, at least in part, on causal saliency at 720. Causal inference learning may be performed on the subset of events at 730 to generate a causal map, which generally refers to the logical relation between events as described above. For certain aspects, interactive learning may also be performed at 740 as described above.

Executed whenever an event occurs, the basic learning method in this example is as follows: (1) determine the augmented causally relevant subset of events including all currently causally salient events and, given a constraint, the most causally related non-current events; (2) determine causal learning for augmented causally relevant event subset and the occurring event; (3) determine causal saliency (predictability of the occurring event), temporal proximity, distinctiveness, and recurrence; and (4) determine a new current causally salient event subset given constraint(s) and update current event temporal frameworks (e.g., on a logarithmic scale).

An example event learning and conversion method may basically include the following: (1) learning temporal patterns in continuous or sampled input; and (2) detecting learned temporal patterns in input and determining the occurrence of events as associated with the occurrence of those patterns.

The interactive method may execute whenever an event occurs, periodically, or as otherwise scheduled and may include the following: (1) comparing learning logical relations with the same effect for different causes to see if causes may be classified in common (generalized); and (2) formulating templates (questions or interventions) (e.g., at 740) for seeking additional input to confirm or refute the candidate generalization(s).

Also, optionally, certain aspects of the present disclosure consider a framework where events are not represented by nodes. Rather, the events may be represented by codes (e.g., population coding instead of spatial coding).

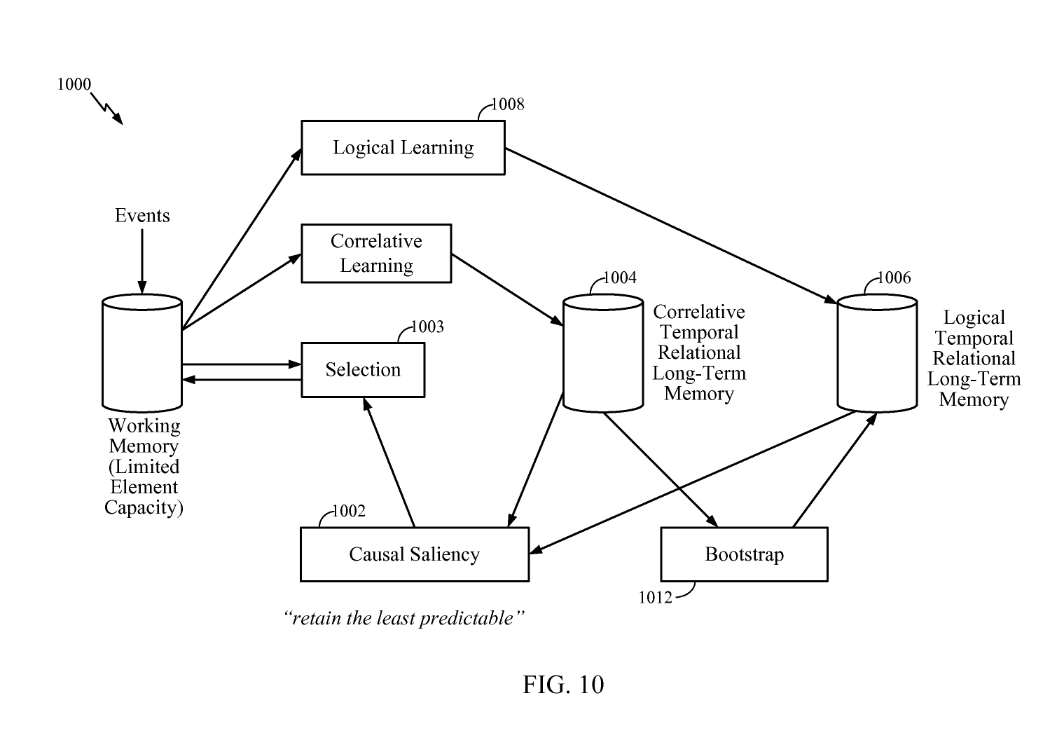

As illustrated in the example causal-saliency causal-inference learning model 1000 of FIG. 10, a fully developed system may include the following conceptual components: causal salience functions 1002, an event selection function 1003 for selecting a subset of events, a flat temporal pair-wise (correlative) map (which may be stored in a correlative temporal relational long-term memory 1004), a logical structural (causal) map (which may be stored in a logical temporal relational long-term memory 1006), a causal inference function 1008, a working memory 1010 for storing events, and a bootstrap function 1012. These components may work together as described above. For example, a structured causality map may be bootstrapped by bootstrap function 1012 using the flat temporal pair-wise (correlative) map of events stored in the correlative temporal relational long-term memory 1004. This bootstrapping may create candidate logical structures for learning on subsequent observations, and such logical structural maps may be stored in the logical temporal relational long-term memory 1006.

### Method of Generating Forward and Backward Logical Probabilities and Logical Tables

Certain aspects of the present disclosure provide methods and apparatus for determining logical causal relationships between events. One example method for generating forward and backward logical probabilities is described below.

Let event e be the pair <ε,τ>, where ε is the event type and τ is the event relative time (a non-positive number). Let there be a mapping to scalar x as follows:

x=f(e)

Let working memory W be a set of events. Let a structure S (e,C) be defined as a relationship between effect event e and a set C of K possible cause events having 2^{K} combinations. Let backward structure S_{b} (e,C) be defined as a vector with 2^{K} entries with mapping to entry j given by

j=g(\hat{C})

where Ĉ is the combination of possible cause events that occurred (i.e., are true). Upon an event e, which by definition will be <ε,0> by nature of occurring at the present time, let entry k of vector S_{b}(e,C) be incremented, where

k=g(C∩W)

Let forward structure S_{f}(e,C) be defined as a vector with 2^{K+1} entries with the same mapping g as the backward structure. Upon an event e, included in the working memory and where the τ of all events in working memory have been updated to reflect current relative time of 0, let A be the set

A=C∪<ε,0>

Let entry l be defined as

l=g(A∩W)

and let entry l of S_{f}(e,C) be incremented. Let entry z be defined as

z=g(φ)

The system need not store and increment entry z of all S_{f}(e,C)'s because that entry's value can be determined by subtracting the sum of non-zero S_{f}(e,C) entries from the total number of events occurred. Now,

$$P ( \hat{C} \vert e = 〈 ɛ , 0 〉 ) = P ( \hat{C} \vert ɛ ) = \frac{{S}_{b} ( e , C ) ( g ( \hat{C} ) )}{{\sum }_{i} {S}_{b} ( e , C ) ( i )}$$

$$and$$

$$\begin{matrix}P ( e = 〈 ɛ , 0 〉 \vert \hat{C} ) = P ( ɛ \vert \hat{C} ) \\ = \frac{{S}_{f} ( e , C ) ( g ( \hat{C} + 〈 ɛ , 0 〉 ) )}{{S}_{f} ( e , C ) ( g ( \hat{C} + 〈 ɛ , 0 〉 ) ) + {S}_{f} ( e , C ) ( g ( \hat{C} - 〈 ɛ , 0 〉 ) )}\end{matrix}$$

where + and − denote explicit set inclusion or exclusion. In the above, one may use the convention that S_{z}(e,C)(i) refers to the i^{th} entry of the vector denoted by S_{z}(e,C).

Computationally, the backward updates access vectors for one outcome event, while the forward updates access vectors from all outcome events having a non-zero intersection set with the working memory. The operations are highly parallelizable (which suggests a neural network). Moreover, the information need not be stored as vectors and, thus, may be highly compressed.

Implementation of the above involves set operations (e.g., intersection) and basic arithmetic. The results are dependent on working memory content. Thus, it may be important to maintain the most causally salient elements in working memory, but it is not necessary to maintain all prior events. The following algorithm form is given:

```
for each event e = [symbol]   ε,0 [symbol]
  for each event w = [symbol]   ω,τ [symbol]   in W
    decrement τ by time elapsed since prior event
  set W′ = W∪e
  for each vector S_{b}(e,C),
    compute k = g(C∩W)
    increment entry k of S_{b} (e,C)
  for each vector S_{f} (x,C) where x may be unconstrained
    compute l = g(W′∩(C∪x))
    increment entry l of S_{f} (x,C)
  set W = W′
```

As an example, let the system have the following observations (sequences of events):

{a, b, c}, {a, b, c}, {a,d,c}, {a,e,c}, {a,b,c}, {a,g,d}, {a,g,e}

Sample structure definitions where C={<a,−2>, <b,−1>} and e=<c,0> for forward and backward vectors are given, after the observations, in the table below. For convenience, the forward vector is divided into two vectors (for c and not c). The actual method of storage or representation is not important.

| Potential Causes | | Index | Effect | S_{b}(e,C) | S_{f}(e,C) | |
|---|---|---|---|---|---|---|
| <a,−2> | <b,−1> | K | <c,0> | Ĉ | Ĉ + < c,0 > | Ĉ − < c,0 > |
| 0 | 0 | 0 | 0/1 | 0 | 0 | 0 |
| 0 | 1 | 1 | 0/1 | 0 | 0 | 0 |
| 1 | 0 | 2 | 0/1 | 2 | 2 | 2 |
| 1 | 1 | 3 | 0/1 | 3 | 3 | 0 |

Thus, for example, P(<c,0>|{<a,−2>,<b,−1>)=1 while P(<c,0>1|<a,−2>,!<b,−1>)=0.5.

### Causal Logical-Temporal-Event Reasoning

### Logical Temporal Event (LTE) Table Entries

A (learned) logical temporal event causal table has rows corresponding to logical combinations of affirmative or negative values for causal events for a particular affirmative or negative outcome event. Each entry can be expressed as a triplet,

y_{r,c}= [symbol] φ_{c},Δt_{c},x_{r,c}

[symbol]

where φ_{c} is the event type, Δt_{c} is the event time relative to the outcome event, and x_{r,c} is the logical value (0/1). A particular row can partially (the set of causing events) be expressed as

\tilde{r}={ [symbol] φⱼ,Δtⱼ,xⱼ [symbol] }

where the x_{r,c} indexing is simplified to the row j for convenience. Note that the events are not necessarily continuous, at equally spaced delays, or even at unique delays. For example, a row may contain negative logical values of two events for the same relative time or may contain events at 1 ms intervals, but with some missing events (not every 1 ms offset).

### Logical Temporal Event (LTE) Masks

However, the outcome may be also associated with that row, so that a full LTE map would be expressed as

\vec{r}_{n,r}={ [symbol] φⱼ,Δtⱼ,xⱼ [symbol] }

where the last n^{th} entry is the outcome and, by convention, Δtₙ=0 and xₙ is either the affirmative (1) or negative (0) table instance. The information contained in a row may also include at least one measure such as probability of the outcome given the logical temporal cause events, and thus, the full information may be represented with the pair of the LTE mask and associated probability metric as

[symbol]

\vec{r}_{n,r},p_{n,r}

[symbol]

where p_{n,r} is the probability metric and without loss of generality, one may consider the affirmative outcome and negative outcome instances of a table as separate rows (different r) of the table or from separate tables (different n).

### Working Memory (WM)

Working memory can also be represented in LTE mask form (vector of triplets) as follows:

\vec{e}={ [symbol] φᵢ,Δtᵢ,xᵢ [symbol] }

where φᵢ is the i^{th} event in working memory, Δtᵢ is the relative time of the event, and xᵢ is the logical value (typically 1 if the working memory is of events that actually happened as opposed to events that did not happen or both, which are also alternatives). By convention, Δtᵢ=0 is the current time, and the last entry (n^{th}) is the last event that occurred and has Δtᵢ=0.

Note that working memory does not necessarily contain all events that have transpired or even all events within some time. There may be missing non-salient events, for example, or observations of multiple events at same times or observations of the absence of events.

### Non-Event-Time-Inconsistency (NETI)

Two LTE masks may be defined to be non-inconsistent in a logic-event-time sense, or non-event-time inconsistent in several ways. One way is logically non-inconsistent (i.e., that there are no two events at the same time that are different and both affirmative or the same and not logically the same). Mathematically,

NETI_{μL}(aᵢ= [symbol] φᵢ,Δtᵢ,xᵢ [symbol] ,bⱼ= [symbol] φⱼ,Δtⱼ,xⱼ [symbol] )≡(Δtᵢ≠Δtⱼ)∥(xᵢ≠xⱼ)∥(φᵢ==φⱼ)

One may also define a time offset NETI where the check is for consistency at a time shift ΔT as follows:

NETI_{μL}=(aᵢ= [symbol] φᵢ,Δtᵢ,xᵢ [symbol] ,bⱼ= [symbol] φⱼ,Δtⱼ,xⱼ [symbol] ΔT)≡(Δtᵢ≠Δtⱼ+ΔT)∥(xᵢ≠xⱼ)∥(φᵢ==φⱼ)

An algorithm might take the following form:

bool NETI_{μL}(aᵢ= [symbol] φᵢ,Δtᵢ,xᵢ [symbol] ,bⱼ= [symbol] φⱼ,Δtⱼ,xⱼ [symbol] ,ΔT)

if (Δtᵢ≠Δⱼ+ΔT)∥(xᵢ≠xⱼ)∥(φᵢ==φⱼ) return true; else return false

The above NETIs are defined for single LTEs. One may define an LTE mask NETI to check consistency of two LTE masks against one another as follows:

$${NETI}_{μ L} ( \vec{a} , \vec{b} , Δ T ) ≡ {\prod }_{i , j} {NETI}_{μ L} ( {a}_{i} , {b}_{i} , Δ T )$$

where the product over all i,j combinations represents ensuring all combinations are not-inconsistent (NETI). Note that one may use this NETI between rows or between working memory and rows and even recursively.

An algorithm might take the following form:

```
bool NETI_{μL}(\vec{a},\vec{b},ΔT)
  foreach i (1..|\vec{a}|)
    foreach j (1..|\vec{b}|)
      if not NETI_{μL}(a ᵢ = [symbol]   φᵢ,Δtᵢ,xᵢ [symbol]  ,bⱼ = [symbol]   φⱼ,Δtⱼ,xⱼ [symbol]  ,ΔT) return
      false
  return true
```

Other NETIs may be defined for other mutual exclusion principles (e.g., no event can occur at two different times). This is equivalent to negative event logic at all times except the time at which the event is affirmative.

### Logical Temporal Event (LTE) Union

One may also define a union of two or more LTE masks as follows. An LTE union is not a simple one-dimensional set union because the elements of the sets are triplets. This means that all unique triplets from the input sets are included in the union result. An element is unique if it differs in any of the triplet values (event type, event time, or logical value).

An example algorithm for an LTE union is as follows:

```
\vec{c} = LTEU(\vec{a},\vec{b},ΔT)
  \vec{c} = \vec{a}
  foreach j (1..|\vec{b}|)
    flag = true
    foreach i (1..|\vec{a}|)
      if (Δtᵢ == Δtⱼ + ΔT)&& (xᵢ == xⱼ )&&(φᵢ == φⱼ) flag = false
    if flag
      \vec{c} = \vec{c}∪ [symbol]   ⱼ
```

Note that the time offset of \vec{c} corresponds to that of the first input of the union \vec{a}. The value ΔT is the time offset to apply to \vec{b}.

By convention, a probability metric may be associated with each LTE mask. For a union of LTE masks, a function may be defined that converts the individual probability metrics of each input mask to one output mask for the union result (another LTE mask) as follows:

P_{1U2}=h(p₁,p₂)

If one considers a table entry probability as a conditional probability of the outcome based on the logical time event inputs, then

pᵣ=P( [symbol] φₙ,Δtₙ,xₙ [symbol] |\tilde{r}ᵣ)

where k is the outcome column and \tilde{r}ᵣ is the input columns. Then, for the union, one has

h(p₁,p₂)=p₁,p₂

### Decisions and Predictions

A typical problem is to determine what to do or what will happen in the future. The LTE unions of working memory and LTE mask from learned logical temporal time tables provide a solution. Suppose for example one wishes to make a decision to try to maximize the chance of a particular outcome. One may take the union of what has happened (WM) of LTE masks in the tables for that desired outcome event for the rows (LTE masks) that are not-inconsistent (NETI) with the working memory. Then, one may select the event in the future (a decision) that has the best probability (post union).

One may demand the existence of a particular event at a particular future time. If first-order unions do not suggest any event at a particular desired time (e.g., the next move in a game or a decision to be made within some time), then one may consider second- or n^{th}-order unions to fill in gaps in causal chains from the present into the future.

This selection may be conditioned on events that are within one's control (actions that are valid). The other side of the coin is prediction. If it is known that the outcome is likely, desired, or targeted, then one may predict the next event(s) from the union results. Moreover, one may do this without assuming any desired or likely outcome by considering some set of tables (not particular tables for some desired outcome).

### First-Order Candidate LTE Masks

One may collect all NETI combinations of candidate LTE masks C¹ of working memory (WM) and \vec{e} and LTE masks \vec{r}_{n,r} for all tables. First-order candidate LTE masks Ĉ¹ may be defined as NETI unions of working memory (WM) and \vec{e} and LTE masks \vec{r}_{n,r} for a set of tables nεD where D is the set of tables (such as tables of desired affirmative or negative outcomes). Thus, one has Ĉ¹⊂C¹.

An example algorithm to build C¹ is as follows:

```
C¹ = FOLTE(tables,\vec{e})
C¹ = Φ
foreach n (1..|tables|)
  foreach \vec{r}(rows(n))
    foreach ΔT(−T...+T)
      if NETI_{μL}(\vec{e},\vec{r},ΔT)
        \vec{f} = LTEU(\vec{e},\vec{r},ΔT)
        C¹ = C¹ ∪ [symbol]   \vec{f},ΔT,pᵣ [symbol]
```

where \vec{e} denotes working memory (WM). Ĉ¹ may be obtained with the same algorithm, but inputting only the “desired” tables D.

By convention, the probability metrics for each LTE mask are included in the sets, as well. The probability metric associated with a working memory LTE mask is typically defined as p=1, because the events in working memory actually happened at this time. However, this is arbitrary, and any nominal value may be used if all first-order candidate LTE masks are unions with the same working memory LTE and compensated for equivalently.

### Second-Order Candidate LTE Masks

To obtain second-order candidate LTE masks, one may take the union of first-order LTE Masks with other first-order LTE masks. For example, one may start with two first-order masks sets: one with only some desired tables D and one with all other tables. To obtain second-order masks, one may take unions of the former with the latter, as in the following example:

```
Ĉⁿ = NOLTE(Ĉⁿ⁻¹,C)
  Ĉⁿ = Φ
  foreach [symbol]   \vec{c},ΔT_{c},p_{c} [symbol]   (Ĉⁿ⁻¹)
    foreach [symbol]   \vec{d},ΔT_{d},p_{d} [symbol]   (C¹)
    if NETI_{μL} [symbol]   \vec{c},\vec{d},ΔT_{c} − ΔT_{d})
      \vec{f} = LTEU(\vec{e},\vec{r},ΔT_{c} − ΔT_{d})
      Ĉⁿ = Ĉⁿ∪ [symbol]   \vec{f},ΔT_{c},h(p_{c},p_{d}) [symbol]
```

where C is C¹, C¹−Ĉⁿ⁻¹, or C−C¹ for example.

This may be put in a loop, as follows:

```
MOLTE(Ĉⁿ⁻¹,C)
  do
    Ĉⁿ = NOLTE(Ĉⁿ⁻¹,C)
    n=n+1
  while Ĉⁿ ≠ Φ || n<=N || max p > P
```

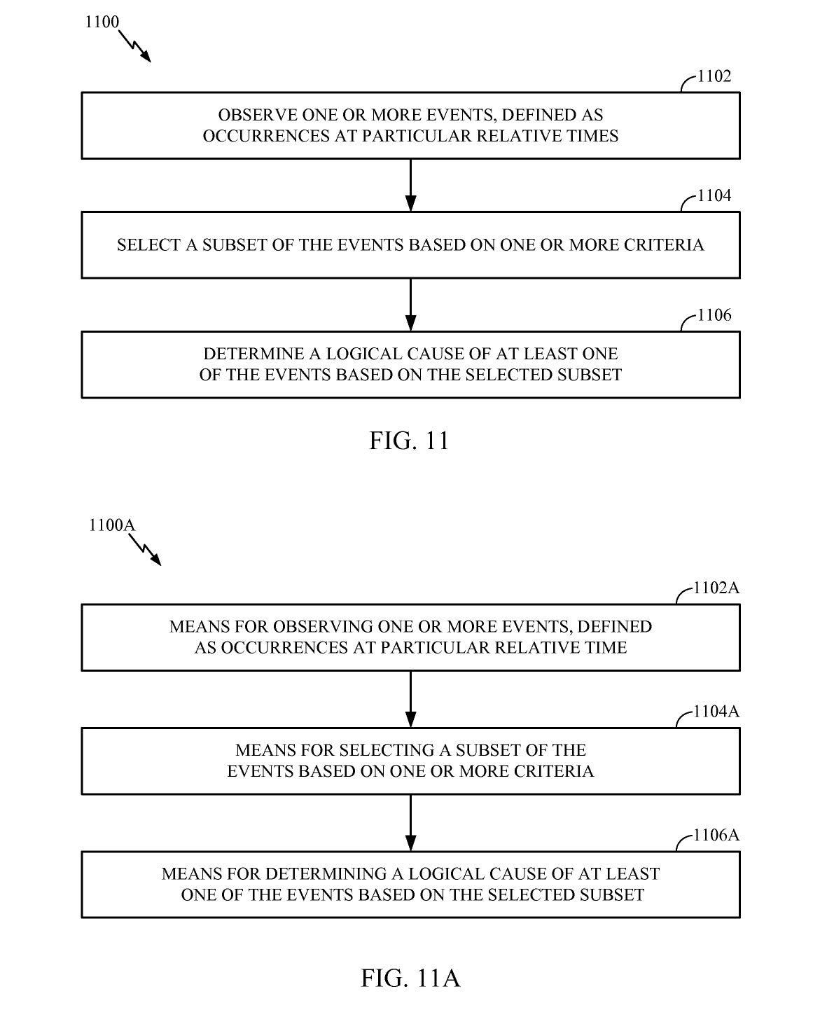

FIG. 11 is a flow diagram of example operations 1100 for causal learning, in accordance with certain aspects of the present disclosure. For certain aspects, the operations 1100 may be implemented in an artificial nervous system (capable of inference learning) and may be performed in hardware (e.g., by one or more neural processing units, such as a neuromorphic processor), in software, or in firmware. The artificial nervous system may be modeled on any of various biological or imaginary nervous systems, such as a visual nervous system, an auditory nervous system, the hippocampus, etc.

The operations 1100 may begin, at 1102, by observing one or more events, defined as occurrences at particular relative times. At 1104, a subset of the events is selected based on one or more criteria. At 1106, a logical cause of at least one of the events is determined, based on the selected subset.

According to certain aspects, the criteria include causal saliency, defined as a degree to which one event stands out from other events. For certain aspects, the more often an unpredictable event takes place, the more causally salient the unpredictable event is. The criteria may include at least one of causal saliency, recurrence, distinctiveness, or temporal proximity.

According to certain aspects, the selecting at 1104 involves considering the earliest of the events providing statistically significant information about another one of the events as the most important events. For certain aspects, the operations 1100 may further include storing the most important events in a memory.

According to certain aspects, the observing at 1102 entails periodically sampling a system to generate a set of discrete points and converting the set of discrete points to the events.

According to certain aspects, the operations 1100 may further include repeating the selecting and the determining if a new event is observed.

According to certain aspects, the operations 1100 may further include predicting one or more subsequent events based on the logical cause.

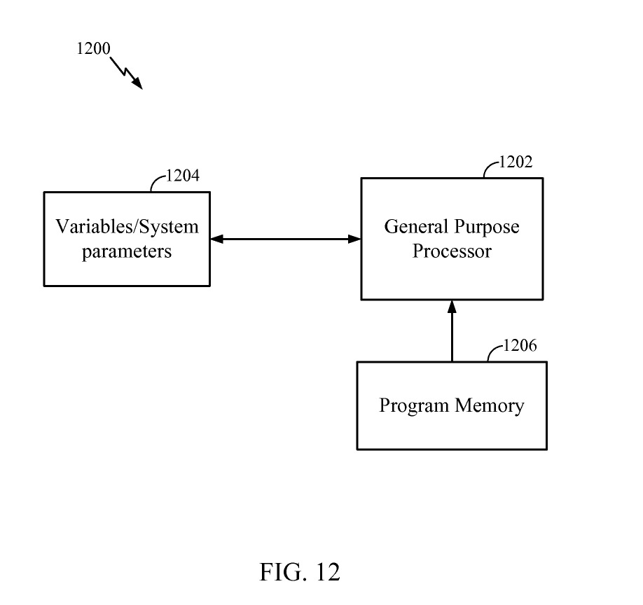

FIG. 12 illustrates an example block diagram 1200 of components for performing the aforementioned method for causal learning using a general-purpose processor 1202, in accordance with certain aspects of the present disclosure. Variables (neural signals), synaptic weights, and/or system parameters associated with a computational network (neural network) may be stored in a memory block 1204, while instructions related executed at the general-purpose processor 1202 may be loaded from a program memory 1206. In an aspect of the present disclosure, the instructions loaded into the general-purpose processor 1202 may comprise code for observing one or more events, defined as occurrences at particular relative times; for selecting a subset of the events based on one or more criteria; and for determining a logical cause of at least one of the events based on the selected subset.

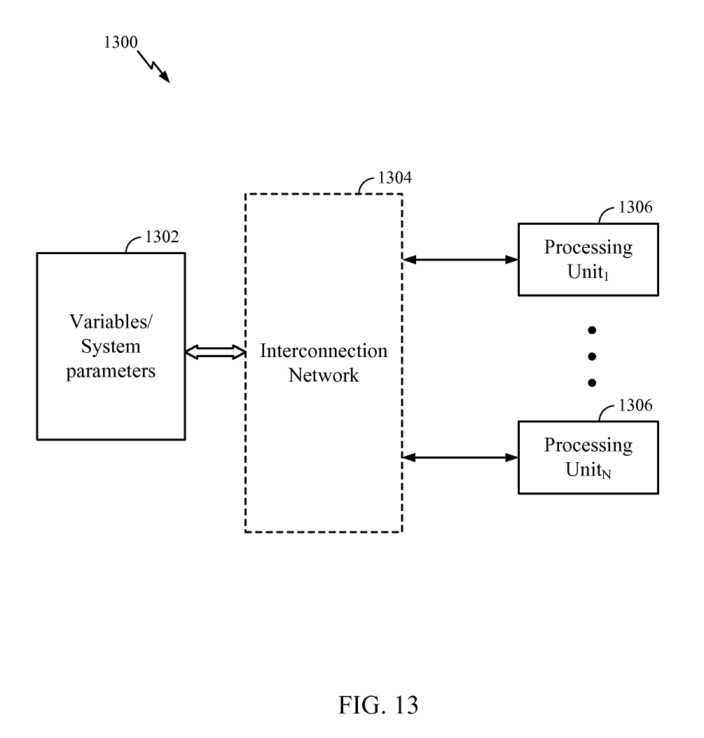

FIG. 13 illustrates an example block diagram 1300 of components for performing the aforementioned method for causal learning, where a memory 1302 can be interfaced via an interconnection network 1304 with individual (distributed) processing units (neural processors) 1306 of a computational network (neural network), in accordance with certain aspects of the present disclosure. Variables (neural signals), synaptic weights, and/or system parameters associated with the computational network (neural network) may be stored in the memory 1302, and may be loaded from the memory 1302 via connection(s) of the interconnection network 1304 into each processing unit (neural processor) 1306. In an aspect of the present disclosure, the processing unit 1306 may be configured to observe one or more events, defined as occurrences at particular relative times; to select a subset of the events based on one or more criteria; and to determine a logical cause of at least one of the events based on the selected subset.

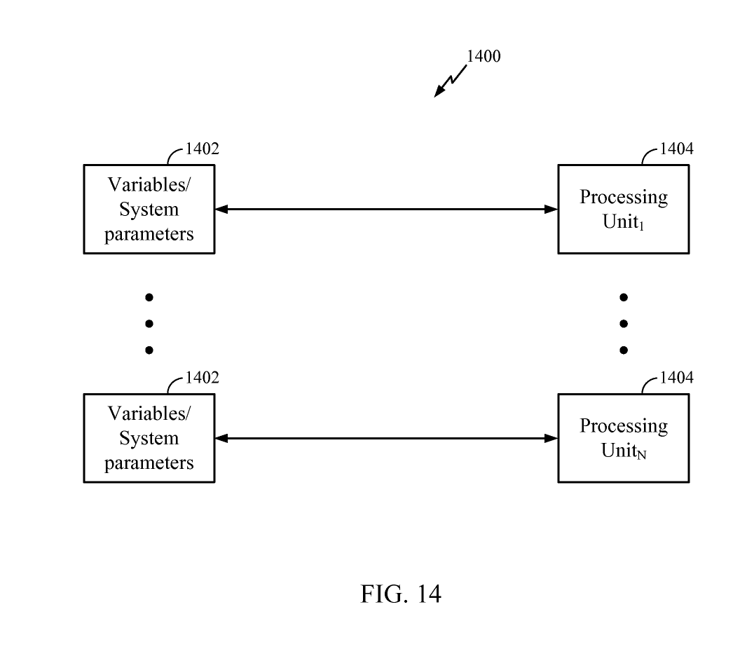

FIG. 14 illustrates an example block diagram 1400 of components for performing the aforementioned method for causal learning based on distributed weight memories 1402 and distributed processing units (neural processors) 1404, in accordance with certain aspects of the present disclosure. As illustrated in FIG. 14, one memory bank 1402 may be directly interfaced with one processing unit 1404 of a computational network (neural network), wherein that memory bank 1402 may store variables (neural signals), synaptic weights, and/or system parameters associated with that processing unit (neural processor) 1404. In an aspect of the present disclosure, the processing unit(s) 1404 may be configured to observe one or more events, defined as occurrences at particular relative times; to select a subset of the events based on one or more criteria; and to determine a logical cause of at least one of the events based on the selected subset.

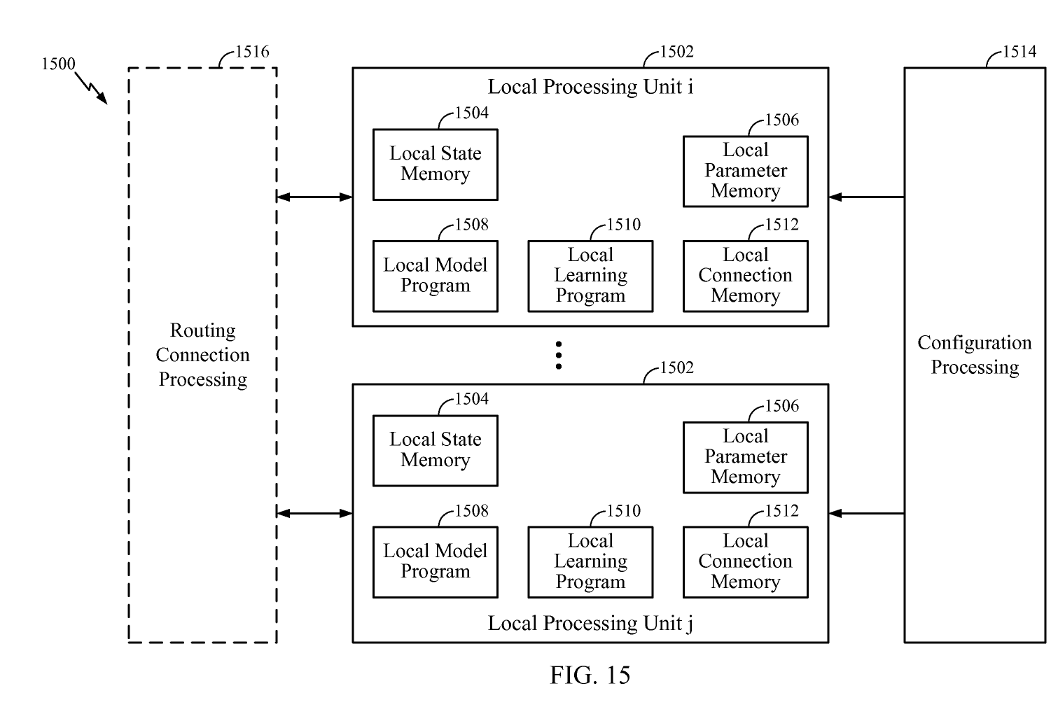

FIG. 15 illustrates an example implementation of a neural network 1500 in accordance with certain aspects of the present disclosure. As illustrated in FIG. 15, the neural network 1500 may comprise a plurality of local processing units 1502 that may perform various operations of methods described above. Each processing unit 1502 may comprise a local state memory 1504 and a local parameter memory 1506 that store parameters of the neural network. In addition, the processing unit 1502 may comprise a memory 1508 with a local (neuron) model program, a memory 1510 with a local learning program, and a local connection memory 1512. Furthermore, as illustrated in FIG. 15, each local processing unit 1502 may be interfaced with a unit 1514 for configuration processing that may provide configuration for local memories of the local processing unit, and with routing connection processing elements 1516 that provide routing between the local processing units 1502.

According to certain aspects of the present disclosure, each local processing unit 1502 may be configured to determine parameters of the neural network based upon desired one or more functional features of the neural network, and develop the one or more functional features towards the desired functional features as the determined parameters are further adapted, tuned and updated.

The various operations of methods described above may be performed by any suitable means capable of performing the corresponding functions. The means may include various hardware and/or software component(s) and/or module(s), including, but not limited to a circuit, an application specific integrated circuit (ASIC), or processor. For example, the various operations may be performed by one or more of the various processors shown in FIGS. 12-15. Generally, where there are operations illustrated in figures, those operations may have corresponding counterpart means-plus-function components with similar numbering. For example, operations 1100 illustrated in FIG. 11 correspond to means 1100A illustrated in FIG. 11A.

For example, means for displaying may include a display (e.g., a monitor, flat screen, touch screen, and the like), a printer, or any other suitable means for outputting data for visual depiction (e.g., a table, chart, or graph). Means for processing, means for observing, means for selecting, means for repeating, means for predicting, or means for determining may comprise a processing system, which may include one or more processors or processing units. Means for sensing may include a sensor. Means for storing may include a memory or any other suitable storage device (e.g., RAM), which may be accessed by the processing system.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for causal learning, comprising:
observing one or more events with an apparatus, wherein the events are defined as occurrences at particular relative times;
selecting a subset of the events based on one or more criteria; and
determining a logical cause of at least one of the events based on the selected subset.

2. The method of claim 1, wherein the criteria comprise causal saliency, defined as a degree to which one event stands out from other events.

3. The method of claim 2, wherein the more often an unpredictable event takes place, the more causally salient the unpredictable event is.

4. The method of claim 1, wherein the criteria comprise at least one of recurrence, distinctiveness, or temporal proximity.

5. The method of claim 1, wherein the selecting comprises considering the earliest of the events providing statistically significant information about another one of the events as the most important events.

6. The method of claim 5, further comprising storing the most important events in a memory.

7. The method of claim 1, wherein the observing comprises:
periodically sampling a system to generate a set of discrete points; and
converting the set of discrete points to the events.

8. The method of claim 1, wherein the method is implemented in an artificial nervous system capable of inference learning.

9. The method of claim 1, further comprising repeating the selecting and the determining if a new event is observed.

10. The method of claim 1, further comprising predicting one or more subsequent events based on the logical cause.

11. An apparatus for causal learning, comprising:
a processing system configured to:
observe one or more events, defined as occurrences at particular relative times;
select a subset of the events based on one or more criteria; and
determine a logical cause of at least one of the events based on the selected subset; and
a memory coupled to the processing system.

12. The apparatus of claim 11, wherein the criteria comprise causal saliency, defined as a degree to which one event stands out from other events.

13. The apparatus of claim 12, wherein the more often an unpredictable event takes place, the more causally salient the unpredictable event is.

14. The apparatus of claim 11, wherein the criteria comprise at least one of recurrence, distinctiveness, or temporal proximity.

15. The apparatus of claim 11, wherein the processing system is configured to select the subset of the events by considering the earliest of the events providing statistically significant information about another one of the events as the most important events.

16. The apparatus of claim 15, wherein the most important events are stored in the memory.

17. The apparatus of claim 11, wherein the processing system is configured to observe the one or more events by:
periodically sampling a system to generate a set of discrete points; and
converting the set of discrete points to the events.

18. The apparatus of claim 11, wherein the apparatus is part of an artificial nervous system capable of inference learning.

19. The apparatus of claim 11, wherein the processing system is further configured to repeat the selecting and the determining if a new event is observed.

20. The apparatus of claim 11, wherein the processing system is further configured to predict one or more subsequent events based on the logical cause.

21. An apparatus for causal learning, comprising:
means for observing one or more events, defined as occurrences at particular relative times;
means for selecting a subset of the events based on one or more criteria; and
means for determining a logical cause of at least one of the events based on the selected subset.

22. A computer program product for causal learning, comprising a non-transitory computer-readable medium having code for:
observing one or more events, defined as occurrences at particular relative times;
selecting a subset of the events based on one or more criteria; and
determining a logical cause of at least one of the events based on the selected subset.
